(19) United States
(12) Patent Application Publication
(10) Pub. No.: US 2025/0188394 A1
(43) Pub. Date: Jun. 12, 2025

(54) A COMPOSITION OF BLENDING WATER FOR ENHANCING FLAVOR OF LIQUOR

(71) Applicant: Devashish Bhaveshbhai KAMDAR, Ahmedabad (IN)

(72) Inventor: Devashish Bhaveshbhai KAMDAR, Ahmedabad (IN)

(21) Appl. No.: 18/845,261

(22) PCT Filed: Oct. 24, 2022
(86) PCT No.: PCT/IN2022/050946

§ 371 Date: Sep. 9, 2024

(30) Foreign Application Priority Data
May 16, 2022 (IN) 202221027938

(51) Int. Cl. C12G 3/06; B01F 21/00; B01F 23/80; B01F 101/16

(52) U.S. Cl. CPC C12G 3/06; B01F 21/02; B01F 23/808; B01F 2101/16; B01F 2215/044; B01F 2215/0472; B01F 2215/0477

(57) ABSTRACT

A composition of blending water for enhancing flavor of liquor. Provided is the composition of the blending water and the process for the preparation thereof wherein the blending water is prepared by purifying impurity and adding some natural extract and salts. Further provided is the preparation of concentrate comprising flavor enhancing agent and base thereof and the blending water use for blend and dilute the liquor.

### FIELD OF THE INVENTION

The present invention relates to the innovative composition of blending water for enhancing the colour, flavour and aroma of liquor. More particularly the present invention relates to the process for preparing the blending water for enhancing the colour, flavour and aroma of liquor. The present invention further relates blending water and application thereof while preparing the liquor for consumption.

### BACK GROUND OF THE INVENTION

Liquor (or a spirit) is an alcoholic drink produced by distillation of grains, fruits, vegetables, or sugar that has already gone through alcoholic fermentation. Other terms for liquor include: spirit drink, distilled beverage or hard liquor. The distillation process concentrates the liquid to increase its alcohol by volume. Like other alcoholic drinks, liquor is typically consumed for the psychoactive effects of alcohol. Liquor may be consumed on its own (“neat”), typically in small amounts. In undiluted form, distilled beverages are often slightly sweet, bitter, and typically impart a burning mouthfeel, with a strong odor from the alcohol: the exact flavour varies between different varieties of liquor and the different impurities they impart. Liquor is also frequently enjoyed in diluted form, as flavored liquor or as part of a mixed drink; with cocktails being a common category of beverage that utilize liquor.

The liquors can be broadly classified into four different types viz Whiskey, Single Malt, Vodka and Gin. Whiskey is type of distilled alcoholic beverage, generally made from fermented grain mash including barley, corn, rye, and wheat. The distinctive taste of the drink is achieved after it is fermented in charred white oak wood. The aging process of whiskey stops once it is bottled from the casks. Up to 40% of alcohol is present in a good whiskey. Vodka is traditionally made from potatoes or fermented cereal grains. Some brands also make it from other substances like fruit or sugar. One of the most used and loved alcoholic drink, vodka is either consumed neat or as cocktails like Martini, Bloody Mary and Cosmopolitan. Similar to vodka, gin gets its name from Juniper berries. It is made from juniper, coriander, citrus peel, cinnamon, almond or liquorice, with neutral grain alcohol. All the flavourings in the gin are natural.

Liquor drinking is a very personal attribute and it relates mainly to the aspects of aroma, taste, colour etc. To drink it, people globally blend or dilute their costly liquor with normal water, soda water or normal packaged drinking water. This blending/dilution generally eliminate the real aroma, flavour, colour within the liquor. Thus, by drinking costly liquor majority people are not being able to experience the real flavour, aroma of their drinks. The reason being that different kinds of water contains different kinds of salts, micronutrients and many other factors which alter the taste of liquor. This alterations are results of interference of liquors constituents with their water counterparts (besides water molecule).

Prior art IN202117002853 discloses a process of improving the flavour and aroma of liquor. Wherein employs a unique edible filtration material to filter out undesired contaminants and improve liquor's structure so that particles within are arranged and blended harmoniously by means of collision and externally applied magnetic field.

United States patent office granted U.S. Pat. No. 10,544,385B2 related to Enhancement of beer flavor by a combination of Pichia yeast and different hop varieties. Wherein the solution is based on the surprising findings by the inventors that by using a method comprising fermenting hopped wort with a Pichia spp. yeast strain prior to or at the same time as fermentation of the hopped wort with a conventional brewer's yeast one is able to produce a beer with an improved flavor profile.

Japan patent JP2012100651A discloses the flavor improver for alcoholic beverage. Wherein inventors have added a predetermined amount of an agent containing mozuku-derived fucoidan as an active ingredient to an alcoholic beverage, thereby causing an unpleasant odor (ethanol-stimulated odor, acid odor, (Sulfur odor, musty odor, fatty odor, etc.) is reduced, preferable fragrance is enhanced, ripening is given, taste is enhanced, sourness is reduced, and the flavor, taste and sourness are improved easily and effectively.

Japan patent JP2007289181A discloses the flavour improver or food and drink having improved flavour by adding flavour improver and method for producing the same. Wherein a flavour improving agent and a flavour improving agent obtained by concentrating an organic acid fermentation liquid obtained by fermenting protein and carbohydrate raw materials, and conventionally by fermentation and long-term aging.

The above mentioned facts in the prior art relates to the improvement of the flavour and related aspects like aroma etc. These improvement per se are done before the dilution and/or consumption of the liquor i.e. at the time of manufacturing of the liquor. None of the above mentioned prior relates and/or describes any kind of modification post preparation/manufacturing of the liquor.

However still there is need to maintain all taste of whiskey, vodka and gin. This problem is solve by present invention by preparing blending water which will be an advantageous and a noteworthy invention.

The present invention relates to enhance the flavour, aroma at the time of consumption of liquor, by diluting/blending with composition of blending water. This enhancement is independent of liquor brand.

Thus, with present invention a person just had to dilute a particular class of liquor with that type of blending water (for e.g. whiskey has to be diluted with whiskey water and so on and so forth). This blending with automatically enhance the flavour, aroma, texture etc., irrespective of brand/make/company. The present invention of blending water works on the chemistry of liquor.

The present invention solve this problem by preparing blending water and to enhance the flavour, aroma and maintain the taste of liquor. Different types of liquors are prepared with different types of ingredients and methods to give them a signature taste. To preserve their signature taste inventor prepared different types of formulation for Whiskey, Single Malt, Vodka and Gin.

### SUMMARY OF THE INVENTION

Therefore the principal object of the present invention is to provide blending water for to enhance and maintain taste, colour, flavour and aroma of liquor.

In an object of the present invention is to provide a composition of concentrate blending water for liquor comprises: concentrate A to moderated pH and TDS is a mixture of sodium carbonate in an amount of 48-50 ppm, sodium Hydroxide in an amount of 28-30 ppm, potassium bicarbonate in an amount of 34-36 ppm; concentrate B to moderated pH and TDS is a mixture of calcium carbonate in an amount of 20-22 ppm, potassium carbonate in an amount of 34-36 ppm, sodium bicarbonate in an amount of 30-32 ppm, calcium Chloride in an amount of 20-22 ppm; composition of concentrate C for test and aroma is a mixture of flavor enhancing agent guaicol in an amount of 20-22 ppm, base selected from sorbitol, glycerin present in an amount of 10-20 ppm; wherein Concentrate A and Concentrate B mixed with stirring for 1-4 hours followed by dropwise addition of Concentrate C with continuous stirring for 10-36 hour.

Another objective of the present invention is to purify water from all kinds of smell, impurity and unneeded salts which can react or alter the taste.

Yet another objective of the present invention is after the purification of water perfect combination of salts and micronutrients with natural extracts are added at a particular concentration, that are needed to enhance the aroma and open all the flavours of liquor.

More particular aspect of the present invention relates to preparation of concentrate solutions and dissolution of the same in specific amount in demineralized water for blending specific liquor.

In more particular object of the present invention provides composition of the blending water comprising Sodium Hydroxide, Sodium Carbonate, Magnesium Hydroxide, Magnesium Carbonate, Calcium Hydroxide, Calcium Carbonate, Potassium Bi carbonate, Sodium Bicarbonate, Ammonium Hydroxide, Magnesium sulphate with each ingredient present in an amount of 1-50 ppm.

Yet another object of the present invention is to enhance the colour, flavour and aroma of liquor by adding flavor enhancing agent selected from guaiacol and glycerin etc. in the water.

In more particular object of the present invention provides process for preparation of composition of concentrate blending water for liquor, wherein process of preparation of said blending water comprises: process of preparation of concentrate A to moderated pH and TDS comprises steps of:
a. dissolving sodium carbonate concentration of 48-50 ppm in 1000 ml of demineralized autoclaved water with TDS in range of 5-10 followed by addition of sodium Hydroxide in an amount of 28-30 ppm.
b. stirring solution formed in step (a) for 30-45 min at 30° C.;
c. addition of potassium bicarbonate in solution formed in step (b) in an amount of 34-36 ppm and followed by stirring for 35-45 minutes to form Concentrate A;
   process of preparation of concentrate B to moderated pH and TDS comprises steps of:
a. addition of 20-22 ppm of calcium carbonate, 16-18 ppm of potassium carbonate & 30-32 ppm of sodium bicarbonate in 1000 ml of water;
b. stirring solution formed in step (d) for 20-40 min at 70° C.;
c. addition of calcium Chloride in solution formed in step (e) in an amount of 20-22 ppm and followed by stirring for 5-15 minutes to form Concentrate B;
   process of preparation of concentrate C for test and aroma comprises steps of:
a. addition 5-10 ppm of guaicol in 1000 ml of water followed by addition 10-20 ppm of sorbitol;
b. stirring solution formed in step (g) for 3 hours at 5° C.;
c. cooling the solution at room temperature to form Concentrate C;
   process of preparation of Concentrate blending water for liquor comprises steps of
a. mixing Concentrate A and Concentrate B with stirring for 2 hours followed by dropwise addition of Concentrate C with continuous stirring for 24 hour.
b. filtration of the solution formed is step (j) to recover final concentrate for preparation of blending water.
c. addition of 60-150 ml of final concentrate in 1000 ml of demineralized water with TDS in the range of 5-10 followed by stirring for one hour to form final blending water for liquor with pH in the range of 6.5-9.0 and TDS in the range of 15-50 ppm.

Another aspect of the present invention is to provide a process of preparation of blending water for to enhance and maintain taste, colour, flavour and aroma of liquor.

Accordingly, in a first aspect, of the present invention the prepared blending water used for blend or dilute the liquor like all kinds of whiskey irrespective of brand, vodka, single malt, gin to maintain all taste, flavour and aroma.

### BRIEF DESCRIPTION OF THE DRAWINGS

The nature of the invention and the more particular aspects of the preferred embodiment disclosed herein will become more apparent following consideration of the ensuing specification and consideration of the attached drawings in which:

FIG. 1: Illustrates the UV-Visible spectrophotometric analysis of anhydrous ethanol as per United States Pharmacopoeia.

FIG. 2: Illustrates the UV-Visible spectrophotometric analysis of Ethanol showing similar solvation at 30% & 80-100% v/v concentration, as compared to the intermediate conditions.

FIG. 3: Illustrates the UV-Visible spectrophotometric analysis of Ethanol showing best solvation at 30% v/v concentration, as compared to higher concentration of 40-60% v/v.

FIG. 4: Illustrates the UV-Visible spectrophotometric analysis of Ethanol showing similar solvation at 30% & 80-100% v/v concentration, as compared to the intermediate conditions.

FIG. 5: Illustrates UV-Visible spectrophotometric analysis of Liquor Blending Water formulations at different pH levels.

FIG. 6: Illustrates the UV-Visible spectrophotometric analysis of whiskey blended in blending water. It is clearly evident that as the pH of the blending water increases. The peak of the blending water gets more and more open. In addition to that, there has been hyper chromic shift pattern of the peak from 270 nm to 280 nm. This shift display a better solvation and thus more taste enhancement of the whiskey.

FIG. 7: Illustrates the UV-Visible Spectra of Whiskey in Blending Water at basic pH range of 9.0 and 9.5. Peak opening is clearly Visible as well as a hyper chromic shift is visible with increase in pH of present blending water.

### DETAILED DESCRIPTION OF THE INVENTION

The term “Ultra filtration”, as used herein, is a variety of membrane filtration in which forces like pressure or concentration gradients lead to a separation through a semipermeable membrane.

“Distillation” as mentioned herein means that process involving the conversion of a liquid into vapour that is subsequently condensed back to liquid form.

“Deionization” as mentioned herein means a physical process that uses specially manufactured ion exchange resins to remove mineral ions.

The term “Reverse osmosis”, as used herein, is a technology that is used to remove a large majority of contaminants from water by pushing the water under pressure through a semipermeable membrane.

During the course of preparation of any kind of liquors, lot of molecules gets involved within it. This molecules are lactones like octanolides based compounds which generally provide woody and spicy kind of flavour.

Another major compounds are phenolic based compounds like guaiacol, which provide smoky and bitter flavour to the liquor. During the preparation these molecules have an intricate arrangement with ethyl alcohol molecules (to be referred to as EtOh). The arrangement is mostly based on the concentration of EtOh.

The present invention provides a blending water makes such kind of molecules to get open up and present on the surface to give a perfect aroma and flavour at each sip of the liquor.

Whiskey preparation it goes through a very long process. During this process, a lots of different kinds of molecules gets accumulated into whiskey. These different kinds of molecules in combination provide flavors, also known as “notes” in liquor industry. These notes are being classified into mainly four types viz: primary, secondary, tertiary. & quaternary. Different brands have different level of notes, some may have up to secondary notes, and others may have up to quaternary notes. But, by using our innovative liquor blending water, whatever the different kinds of notes that are present in undiluted/neat whiskey do remain intact upon blending. In addition to that, since the whiskey is also getting diluted with the flavour remaining intact, the dilution results in ease of drinking by removing the excess punchiness of the whiskey. Thus via blending water, you get a dual benefit of taste enhancement as well as smooth drinking experience. In addition to that it takes away the punchiness of the whiskey or per se other liquor and provides a smooth drinking experience.

Therefore an aspect of the present invention is to provide and developed a special blending water also to be known as Liquor Blending water. Under Liquor Blending water (hereby to be referred to as blending water), there are four major varieties viz 1: Whisky Blending Water 2: Single Malt Blending water 3: Vodka Blending Water 4: Gin Bending Water. Here, the above mentioned varieties are not limited to the above mentioned classes. But it includes and shall be considered and are suitable for all kinds of liquor brands consumed. This is because of the nature of Blending Water, as it can be modified and/or customized suitably. This Blending water has been uniquely innovated for blending whiskies (or any other kind of liquor) be-fore drinking. This kind of belting water has been developed for very first time, specially designed for diluting/blending whiskies (from here on whisky means all kinds of liquor that are being used for drinking purposes). The idea and specialty of our blending water is to enhance the flavour of whiskey.

Ethyl Alcohol (hereby referred to as Ethanol) is a hydrophilic molecule and thus it is readily soluble in water. In addition to that, ethanol is also an organic molecule that contains hydrophobic part at one end and hydrophilic part at one end. Due to this amphipathic nature of the molecule, it behaves differently when dissolve in water as compared to other polar or hydrophilic molecules. The hydrophobic part consists of ethyl group (—C₂H₅) and hydrophilic part consists of hydroxy group (—OH). When ethanol is added in water, it behaves like lipid molecules, where hydrophobic groups get accumulated on inner side and hydrophilic groups remain exposed on the outer side. On a similar pattern ethyl group (—C₂H₅) form a cluster on inner side. On the outer side remains the hydroxyl group (—OH). This kind of cluster formation results in the mixing of ethanol in water. Such kind of mixing of both the molecules is an inefficient kind of mixing. Because of this an increase in the final entropy of the mixture is less than expected. This less increment in the entropy as compared to the normal entropy increase is due to restricted movement of the ethanol molecules in water. The above phenomenon explained is also referred to as clathrate (means cage) like structure formation. This formation has been shown by neutron diffraction studies, where it has been shown that water molecules exist as small clusters/strings attached to each other via hydrogen bond. Generally, the water cluster consists of three molecules in a row. These cluster exists over fluid like structure of closely packed ethyl groups (—C₂H₅).

For the present invention nature of alcohol is considered as to whisky and vodka. But this technology works very well on all kinds of liquor brands. On an average whiskey contains around 42% v/v ethanol. But in addition to that it also contains other phenolic based compounds like guaiacol, vanillin and related com-pounds like this. These kinds of additional compounds get incorporated in to the whiskey during distillation, ageing and other production processes. Although the exact concentration may vary from one brand to another. Particularly guaiacol in combination with ethanol creates the signature smoky flavour of the whiskey that is prevalent all over the world. Guaiacol is the next most abundant molecule in the whiskey after ethanol. It's a phenolic compound and has the ability to interact with polar solvents via hydrogen bonding and polar aromatic interactions.

Thus, due to its taste many whiskey enthusiasts like to consume the whiskey in neat format especially for its taste. But, mixing of water with whiskey results in reduction of the signature taste. This reduction, is mainly due to two reasons viz 1: dilution in the concentration of the whisky as compared to the neat. 2: embedding of the hydrophobic part of the ethanol and guaiacol (due to the formation of clathrin hydrate structure as mentioned above). This flavour reduction is independent of the whiskey brand.

To understand better, guaiacol is also an alcoholic compound as it contains the hydroxyl group attached to phenyl (C6H5-) group with a methoxy group at ortho position in reference with the hydroxyl group. The hydrophobic part of the guaiacol is bigger as compared to ethanol. So as explained above the hydrophobic part of guaiacol (method phenyl group) is more embedded as com-pared to the ethyl group (C2H5-). But it is also associated with the water molecules via hydrogen bonding.

Thus, it can be understood from the above discussion that hydrogen bonding within the mixture is of two types
1. H-bonding among the water molecules that results in the formation of water cluster. (Hereby referred to as intra hydrogen bonding)
2. H-bonding between the H group of water and —OH group of ethanol/guaiacol. (Hereby referred to as inter-H-Bonding).

Therefore, an aspect of the present invention focused on to enhance the mixing of whiskey with water by disrupting the existing hydrogen bonding. By alteration in H-bonding, it means increment or reduction of existing hydrogen bonding. This alteration mostly happens via the process of proton exchange, where H+ and OH− moves over the bond. In our case proton exchange will occur between H+ of water and OH− of ethanol & Guaiacol and simultaneous exchange between H+ of water and Oh− of water. With reduction in H-bonding will result in the reduction in cluster formation (as cluster formation depends mostly on the hydrogen bonding). Less cluster formation means better salvation of the ethanol and guaiacol molecules. Better salvation means better flavour enhancement of the whiskey upon dilution with our flavour enhancement water.

There are various ways of altering hydrogen bonding viz: 1: temperature 2: Solute/Solvent concentration 3: pH alteration 4: presence of any kind of co factors, etc.

Therefore, present invention includes a preparation of such kind of water having a formulation within it that upon mixing with the whiskey will instantaneously release the hydrogen bonding, resulting in better mixing of the whiskey and water. The present invention relates to a composition consists of a combination of salts containing chlorides, carbonates, hydroxides, sulphates, nitrates, nitrites. The above combination consist of sodium, potassium, calcium, magnesium, manganese, aluminium and the related alkali and alkaline metal salts.

In a further aspect of the present invention about the present mixture that it is prepared in such a fashion that when added to a water a concentration ranging from (5 ppm to 1000 ppm). In an embodiment of the present invention is to provide a composition of concentrate blending water for liquor comprises: concentrate A to moderated pH and TDS is a mixture of sodium carbonate in an amount of 48-50 ppm, sodium Hydroxide in an amount of 28-30 ppm, potassium bicarbonate in an amount of 34-36 ppm; concentrate B to moderated pH and TDS is a mixture of calcium carbonate in an amount of 20-22 ppm, potassium carbonate in an amount of 34-36 ppm, sodium bicarbonate in an amount of 30-32 ppm, calcium Chloride in an amount of 20-22 ppm; composition of concentrate C for test and aroma is a mixture of flavor enhancing agent guaicol in an amount of 20-22 ppm, base selected from sorbitol, glycerin present in an amount of 10-20 ppm; wherein Concentrate A and Concentrate B mixed with stirring for 1-4 hours followed by dropwise addition of Concentrate C with continuous stirring for 10-36 hour.

In an embodiment of the present invention additional ingredients are added for the preparation of premium liquor selected from honey, fudge, vanilla, cinnamon, black paper, plump, orange, figs, citrus, barley sugar, dark chocolate, pear, dried fruits, oak, sherry, cereal, charcoal, fruits, malt syrup, cherries, nuts, sponge cake, raspberries, green pine, peat, coffee, caramel, brown sugar, sandalwood, butterscotch, cream, wild herbs and many more to give whiskey fruity, sweet, spicy and smoky taste.

In main embodiment of the present invention provides a blending water for blend and dilute the liquor and to maintain all taste, flavor and aroma of liquor.

In an embodiment of the present invention provides flavor enhancing agent for a blending water is guaicol.

In a further embodiment of the present invention further provides base for the flavor enhancement is selected from sorbitol, glycerin.

In a further embodiment of the present invention further provides process for the preparation of blending water. In more particular embodiment of the present invention provides process for preparation of composition of concentrate blending water for liquor, wherein process of preparation of said blending water comprises: process of preparation of concentrate A to moderated pH and TDS comprises steps of:
d. dissolving sodium carbonate concentration of 48-50 ppm in 1000 ml of demineralized autoclaved water with TDS in range of 5-10 followed by addition of sodium Hydroxide in an amount of 28-30 ppm.
e. stirring solution formed in step (a) for 30-45 min at 30° C.;
f. addition of potassium bicarbonate in solution formed in step (b) in an amount of 34-36 ppm and followed by stirring for 35-45 minutes to form Concentrate A;
   process of preparation of concentrate B to moderated pH and TDS comprises steps of:
d. addition of 20-22 ppm of calcium carbonate, 16-18 ppm of potassium carbonate & 30-32 ppm of sodium bicarbonate in 1000 ml of water;
e. stirring solution formed in step (d) for 20-40 min at 70° C.;
f. addition of calcium Chloride in solution formed in step (e) in an amount of 20-22 ppm and followed by stirring for 5-15 minutes to form Concentrate B;
   process of preparation of concentrate C for test and aroma comprises steps of:
d. addition 5-10 ppm of guaicol in 1000 ml of water followed by addition 10-20 ppm of sorbitol;
e. stirring solution formed in step (g) for 3 hours at 5° C.;
f. cooling the solution at room temperature to form Concentrate C;
   process of preparation of Concentrate blending water for liquor comprises steps of
d. mixing Concentrate A and Concentrate B with stirring for 2 hours followed by dropwise addition of Concentrate C with continuous stirring for 24 hour.
e. filtration of the solution formed is step (j) to recover final concentrate for preparation of blending water.
f. addition of 60-150 ml of final concentrate in 1000 ml of demineralized water with TDS in the range of 5-10 followed by stirring for one hour to form final blending water for liquor with pH in the range of 6.5-9.0 and TDS in the range of 15-50 ppm.

In an embodiment of the present invention provides the process for preparation comprises purification of the water from all kinds of smell, impurity and unneeded salts which can react or alter the taste.

Followed by the purification of the water addition of suitable combination of salts and micronutrients with natural extracts are added at a particular concentration, that are needed to enhance the aroma and open all the flavours of liquor.

In another embodiment of the present invention, more particularly the following steps describe the process for the preparation of blending water are comprises steps as:
i. Purification of water using simple spun filter in order to remove all impurities.
ii. Filtering water by passing through carbon filters to remove all kinds of organic impurities and smell.
iii. Removing the unwanted salts by Ultra filtration, Distillation, Deionization, reverse osmosis etc. Water obtained through steps i to iii makes water pure, smell less and tasteless.
iv. Addition of specific salts selected from potassium, sodium, magnesium, calcium, bicarbonates, carbonates, charcoal to treated purified water obtained through process i to iii.
v. Addition of specific natural extract selected from citrus, oak wood extract, guaiacol etc. are added to water.

In another embodiment also describe all the ingredients are added in different proportion for different blending water. These all ingredients will enhance the colour, flavour and aroma of liquor.

Thus, present invention is specialty water (also to be referred to as liquor blending water) that can be consumed, consideration of all the hazardous effects of whiskey on liver and drinking neat whisky over a long period of time that led to detrimental effects in health of the person. Therefore in another aspect of the present invention drinking neat whiskey can be avoided by consumer as the present invention has been focused on homogenous mixing of the water, ethanol, guaiacol and related compounds for enhanced drinking experience.

The process for preparing the present novel blending water for liquor and composition thereof can be modified accordingly by any person skilled in the art based on the knowledge of the manufacturing the formulation. However, all such variation and modification are still covered by the scope of present invention.

### Example 1: Preparation of Concentrate Blending Water for Liquor

Following Table 1 depicts composition for Concentrate blending water for liquor comprising ingredient present in specific range.

TABLE 1

| | | Range of |
|---|---|---|
| Sr. no | Name of Ingredient | Amount |
| 1. | Sodium Carbonate | 1-50 ppm |
| 2. | Sodium Hydroxide | 1-50 ppm |
| 3. | Potassium Bicarbonate | 1-50 ppm |
| 4. | Calcium Carbonate | 1-50 ppm |
| 5. | Potassium carbonate | 1-50 ppm |
| 6. | Sodium Bicarbonate | 1-50 ppm |
| 7. | Calcium Chloride | 1-50 ppm |
| 8. | Guaicol | 2-5 ppm |
| 9. | Sorbitol | 5-6 ppm |

### Process of Preparation of Blending Water:

Water was passed through reverse osmosis system to demineralize the water in the TDS (total dissolved solid) range of 5-10 ppm. Further water was autoclaved for complete removal of of microbiological impurities present in the water. This water was utilised for all further preparations.

### Preparation of Concentrate a to Moderated pH and TDS

Dissolving 48-50 ppm sodium carbonate in 1000 ml of demineralized autoclaved water with TDS in range of 5-10 followed by addition of 28-30 ppm sodium Hydroxide. The solution was stirred for 30-45 min at 30° C. 34-36 ppm of potassium bicarbonate was added in solution and followed by stirring for 35-45 minutes to form Concentrate A.

### Preparation of Concentrate B to Moderated pH and TDS

Dissolve 20-22 ppm of calcium carbonate, 16-18 ppm of potassium carbonate & 30-32 ppm of sodium bicarbonate in 1000 ml of water. The solution was stirred for 20-40 min at 70° C. 20-22 ppm of calcium chloride was added in solution and followed by stirring for 5-15 minutes to form Concentrate B.

### Preparation of Concentrate C for Test and Aroma:

Dissolve 5-10 ppm of guaicol in 1000 ml of water followed by addition 10-20 ppm of sorbitol. The solution was stirred for 3 hours at 5° C. The solution was cooled at room temperature to form Concentrate C.

### Preparation of Concentrate Blending Water for Liquor

Mixing Concentrate A and Concentrate B with stirring for 2 hours followed by dropwise addition of Concentrate C with continuous stirring for 24 hour. The solution was filtered to recover final concentrate for preparation of blending water.

Preparation of blending water for liquor is selected from whiskey, vodka, single malt, gin addition of 60-150 ml of Concentrate blending water for liquor in 1000 ml of demineralized water having TDS in the range of 5-10 ppm and pH in the range of 6.5-6.8 followed by stirring for one hour to form final blending water for liquor with pH in the range of 6.5-9.0 and TDS in the range of 15-50 ppm, wherein liquor is selected from whiskey, vodka, single malt, gin.

Following the right use of the invented technology and the blending water composition of the invention with a formulation having a multiple component.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention. The invention shall now be described with reference to the following specific examples. It should be noted that the example(s) appended below illustrate rather than limit the invention, and that those skilled in the art will be able to design many alternative embodiments without departing from the scope of the present invention.

These and other aspects of the invention may become more apparent from the examples set forth herein below. These examples are provided merely as illustrations of the invention and are not intended to be construed as a limitation thereof.

### Example 2: Preparation of the Whiskey Blending Water

Take approx 112 ml of concentrate blending water for liquor (Example 1) and added to 1 litres of distilled water (having TDS in the range of 5-10 ppm and pH in the range of 6.5-6.8) and was mixed for 1 hour. The final pH and TDS of the whiskey blending water is pH 7.9-8.3 and TDS 25-36 ppm.

Table 2 depicts composition for concentration ingredient present in blending water for whisky comprising specific range.

TABLE 2

| Sr. no | Name of Ingredient | Amount |
|---|---|---|
| 1. | Sodium Carbonate | 10 |
| 2. | Sodium Hydroxide | 2 |
| 3. | Potassium Bicarbonate | 2 |
| 4. | Calcium Carbonate | 5 |
| 5. | Potassium carbonate | 1 |
| 6. | Sodium Bicarbonate | 2 |
| 7. | Calcium Chloride | 3 |
| 8. | Guaicol | 2 |
| 9. | Sorbitol | 5 |

The final pH and TDS of the whiskey blending
water is pH 8.3 and TDS 30 ppm

### Example 3: Preparation of the Whiskey Blending Water

Take approx 120 ml of concentrate blending water for liquor (Example 1) and added to 1 litres of distilled water (having TDS in the range of 5-10 ppm and pH in the range of 6.5-6.8) and was mixed for 1 hour. The final pH and TDS of the whiskey blending water is pH 7.9-8.3 and TDS 25-36 ppm.

Table 3 depicts composition for concentration ingredient present in blending water for whisky comprising specific range.

TABLE 3

| Sr. no | Name of Ingredient | Amount |
|---|---|---|
| 1. | Sodium Carbonate | 10 ppm |
| 2. | Sodium Hydroxide | 2 ppm |
| 3. | Potassium Bi carbonate | 2 ppm |
| 4. | Calcium Carbonate | 13 ppm |
| 5. | Potassium carbonate | 1 ppm |
| 6. | Sodium Bicarbonate | 3 ppm |
| 7. | Calcium Chloride | 2 ppm |
| 8. | Guaicol | 5 ppm |
| 9. | Sorbitol | 4 ppm |

The final pH and TDS of the whiskey blending
water is pH 8.5 and TDS 36 ppm

### Example 4: Preparation of the Single Malt Blending Water

Take approx 96.5 ml of concentrate blending water for liquor (Example 1) and added to 1 litres of distilled (having TDS in the range of 5-10 ppm and pH in the range of 6.5-6.8) and was mixed for 1 hour. The final pH and TDS of the single malt blending water is pH 7.3-7.8 and TDS 20-35 ppm.

Table 4 depicts composition for concentration ingredient present in blending water for single malt comprising specific range.

TABLE 4

| Sr. no | Name of Ingredient | Amount |
|---|---|---|
| 1. | Sodium Carbonate | 10 ppm |
| 2. | Sodium Hydroxide | 15 ppm |
| 3. | Potassium Bi carbonate | 3 ppm |
| 4. | Calcium Carbonate | 2 ppm |
| 5. | Potassium carbonate | 5 ppm |
| 6. | Sodium Bicarbonate | 3 ppm |
| 7. | Calcium Chloride | 4 ppm |
| 8. | Guaicol | 5 ppm |
| 9. | Sorbitol | 6 ppm |

The final pH and TDS of the single malt
blending water is pH = 7.5 and TDS = 33 ppm

### Example 5: Preparation of the Gin Blending Water

Take approx 142 ml of concentrate blending water for liquor (Example 1) and add to 1 litres of distilled (having TDS in the range of 5-10 ppm and pH in the range of 6.5-6.8) and was mixed for 1 hour. The final pH and TDS of the gin blending water is pH 8.0-8.7 and TDS 25-45 ppm. Table 5 depicts composition for concentration ingredient present in blending water for Gin comprising specific range.

TABLE 5

| Sr. no | Name of Ingredient | Amount |
|---|---|---|
| 1. | Sodium Carbonate | 18 ppm |
| 2. | Sodium Hydroxide | 5 ppm |
| 3. | Potassium Bi carbonate | 15 ppm |
| 4. | Calcium Carbonate | 2 ppm |
| 5. | Potassium carbonate | 2 ppm |
| 6. | Sodium Bicarbonate | 5 ppm |
| 7. | Calcium Chloride | 4 ppm |
| 8. | Guaicol | 5 ppm |
| 9. | Sorbitol | 6 ppm |

The final pH and TDS of the Gin blending
water is pH = 8.7 and TDS = 45 ppm

### Example 6: Preparation of the Vodka Blending Water

Take approx 75-80 ml of concentrate blending water for liquor (Example 1) and add to 1 litres of distilled (having TDS in the range of 5-10 ppm and pH in the range of 6.5-6.8) and was mixed for 1 hour. The final pH and TDS of the vodka blending water is pH 6.5-7.0 and TDS 18-25 ppm. Table 6 depicts composition for concentration ingredient present in blending water for vodka comprising specific range.

TABLE 6

| Sr. no | Name of Ingredient | Amount |
|---|---|---|
| 1. | Sodium Carbonate | 5 ppm |
| 2. | Sodium Hydroxide | 3 ppm |
| 3. | Potassium Bi carbonate | 1 ppm |
| 4. | Calcium Carbonate | 1 ppm |
| 5. | Potassium carbonate | 1 ppm |
| 6. | Sodium Bicarbonate | 1 ppm |
| 7. | Calcium Chloride | 1 ppm |
| 8. | Guaicol | 2 ppm |
| 9. | Sorbitol | 5 ppm |

The final pH and TDS of the vodka blending
water is pH = 6.7, and TDS = 20 ppm

### Example 7: Preparation of the Gin Blending Water

Take approx 122 ml of concentrate blending water for liquor (Example 1) and add to 1 litres of distilled (having TDS in the range of 5-10 ppm and pH in the range of 6.5-6.8) and was mixed for 1 hour. The final pH and TDS of the gin blending water is pH 8.0-9.0 and TDS 25-50 ppm. Table 7 depicts composition for concentration ingredient present in blending water for Gin comprising specific range.

TABLE 7

| Sr. no | Name of Ingredient | Amount |
|---|---|---|
| 1. | Sodium Carbonate | 5 ppm |
| 2. | Sodium Hydroxide | 3 ppm |
| 3. | Potassium Bicarbonate | 5 ppm |
| 4. | Calcium Carbonate | 10 ppm |
| 5. | Potassium carbonate | 15 ppm |
| 6. | Sodium Bicarbonate | 1 ppm |
| 7. | Calcium Chloride | 1 ppm |
| 8. | Guaicol | 2 ppm |
| 9. | Sorbitol | 5 ppm |

The final pH and TDS of the Gin blending
water is pH = 8.8 and TDS = 47 ppm

### Example 8: Preparation of the Whiskey Blending Water

Take approx 110 ml of concentrate blending water for liquor (Example 1) and added to 1 litres of distilled water (having TDS in the range of 5-10 ppm and pH in the range of 6.5-6.8) and was mixed for 1 hour. The final pH and TDS of the whiskey blending water is pH 7.9-8.3 and TDS 25-36 ppm.

Table 8 depicts composition for concentration ingredient present in blending water for whisky comprising specific range.

TABLE 8

| Sr. no | Name of Ingredient | Amount |
|---|---|---|
| 1. | Sodium Carbonate | 10 ppm |
| 2. | Sodium Hydroxide | 2 ppm |
| 3. | Potassium Bicarbonate | 2 ppm |
| 4. | Calcium Carbonate | 5 ppm |
| 5. | Potassium carbonate | 15 ppm |
| 6. | Sodium Bicarbonate | 2 ppm |
| 7. | Calcium Chloride | 3 ppm |
| 8. | Guaicol | 2 ppm |
| 9. | Sorbitol | 5 ppm |

The final pH and TDS of the whiskey blending
water is pH 8.3 and TDS 29 ppm

Following examples are validating the present invention:

### Example 9: Analysis of Pure Anhydrous Ethanol

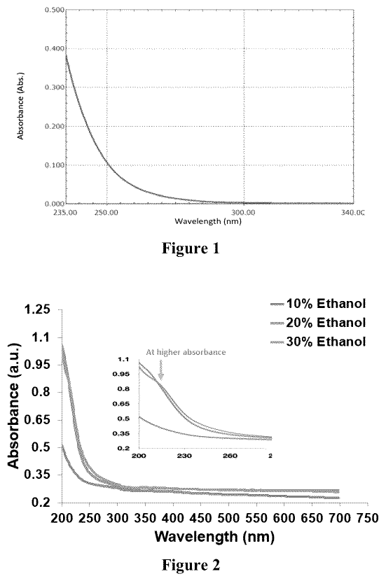

Applicant has analyzed and understood the nature of ethanol via UV-vis spectroscopy. For analysis we used United States Pharmacopoeia (USP) as a standard reference. As per USP for UV vis analysis are done majorly at two points viz: 1: 240 nm wavelength 2:250-260 nm wavelength range. Both the ranges have a particular absorbance value for 240 nm it is NMT 0.4 and for the later it is NMT 0.3. When anhydrous ethanol was run in UV Vis sample, at a spectral span of 200 nm to 800 nm. Based on that absorbance value were recorded and it was found to be in accordance with the USP standards as depicted in FIG. 1.

### Example 10: Understanding the Solvation of Different Concentrations of Ethanol, Followed by Finding the Solvation Effect of Ethanol in Water

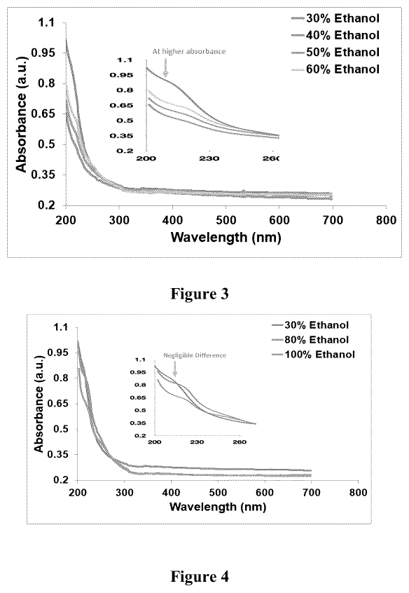

Solvation effects means at which concentration does ethanol gets dissolved more homogeneously. So we did a UV vis spectral analysis from 10% v/v to 100% v/v. We observed that from 10% to 30% v/v, ethanol molecule dissolves more homogeneously in an increasing trend. At 30% v/v we observed maximum peak opening at the wavelength range of 200-240 nm. After 30% v/v, starting from 40% v/v the peak in the 200-240 nm ranges stars depressing below the peak of 30% v/v up to 60% v/v. But the peak of 30% v/v almost matches to 80% v/v and 100% v/v concentration. This means that at around 30% v/v ethanol molecule dissolved majorly in a homogenous pattern. That is in the accordance with the absorbance values at 30% v/v and 80% v/v which are in similar range. As depicted in FIG. 2, FIG. 3 & FIG. 4, if the peak is opening up more or forming a plateau like pattern as compared to other concentrations. Then this means that at particular concentration, the molecule is being better dissolved and thus it absorbs more light. Based on that, we decided to do our further experiments at 30% v/v concentrations to test our Liquor blending water. Also in real life practice, it has been observed that majority of people drink whiskey, where they mix around 30 ml of whiskey in 100 ml of water or related diluent. This combination is referred to as one peg. By this analysis, it should not be understood that by varying ethanol concentration the dissolving capacity of ethanol changes. But instead it tells us as how better and homogeneously it dissolves.

### Example 11: Solvation Analysis of Liquor Blending Water

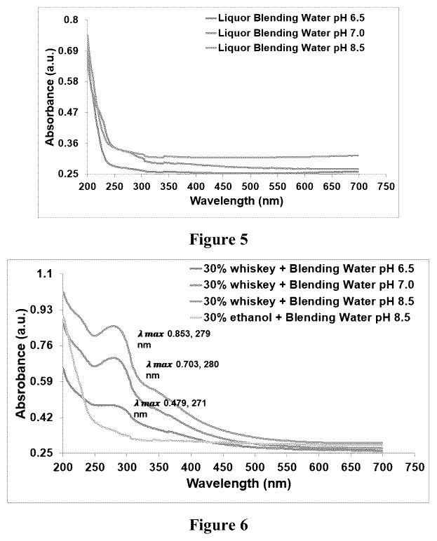

Further applicant/inventor has the analyzed of our present Liquor blending water. For that, /inventor has prepared blending water as per our protocol. Our proprietary formula was developed at three different pH levels viz. 6.5, 7.0 & 8.5. The idea of developing our formula at three different levels is generally ethanol pH revolves around from 7.0 to 7.3. In addition to that, as per WHO standards drinking should be done at a pH range of 6.5-8.5. After preparation, we checked our via Uv-vis spectral analysis of all the three samples. It was observed that lambda max of 6.5 and 7.0 pH were in increasing trend with a marginal increase, whereas at pH 8.5 there was an increment in the lambda max of 0.1 absorbance unit. So, we can infer that our proprietary formula will allow better solvation towards basic pH. FIG. 5 depicts UV-visible spectroscopy analysis of Liquor Blending Water formulations at different pH levels.

### Example 12: Effect of Liquor Blending Water on Whisky at Molecular Level Via Uv-Vis Spectral Analysis

Followed by the above mentioned analysis, applicant did the analysis of as to how Liquor blending water is enhancing the flavour and essence of whisky upon dilution. For this we took a whisky. This whisky has been supposedly to have a typical smoky flavour and tanginess when drunk neat. So we prepared a typical peg consisting of 30 ml whisky and 70 ml of Liquor drinking water, making the final solution of 100 ml including both. At first we took a similar concentrated alcohol i.e. 30% v/v and dissolved it in our Liquor Blending water made at pH 6.5. UV-vis spectral analysis displayed a smooth curve of ethanol as per United States Pharmacopoeia. But in whiskey, we observed a λ max at 271 nm, with an absorption value of 0.479. Next the same experiment was repeated but with Liquor blending water used at pH 7.0. We observed in Uv-vis spectral analysis, a λ max at 280 nm, with an absorption value of 0.703. Here we observed an 1.46 times increment in absorbance value. In addition to that a hyper chromic peak shift was observed. Next we again repeated the experiment, with Liquor blending water of pH 8.5. We observed in Uv-vis spectral analysis, a λ max at 279 nm, with an absorption value of 0.853. Here, the lambda max was almost similar to Liquor Blending water pH 7.5. But still there was an increase in the absorbance value from 0.7 to 0.853 i.e. an increment of 1.2 times. This absorption peak when compared to the existing scientific data, was found to be of guaiacol. As explained above, if the peak is getting more prominent. This means, that absorbance of the light is getting enhanced. In this case, guaiacol molecule peak is getting more enhanced, which means that upon blending with our water this molecule is getting more and more openly dissolved in solution. Openly means that guaiacol molecule is being less surrounded by water molecules. Thus, due to that when the light passes through this solution, guaiacol molecules absorbs more light. So if the molecules are not being masked by the water molecules, then during drinking it will give more smoky and tanginess based flavour. The values and taste were similar to Liquor blending water at pH 8.5. Thus, if we want to open the taste of liquor we can used Liquor water at basic pH and if we want to lower the taste of the liquor than we can use neutral to mild acidic pH Liquor water based on the customer needs. FIG. 6 depicts the UV-Visible spectrophotometric analysis of whiskey blended in blending water. It is clearly evident that as the pH of the blending water increases. The peak of the blending water gets more and more open. In addition to that, there has been hyper chromic shift pattern of the peak from 270 nm to 280 nm. This shift display a better solvation and thus more taste enhancement of the whiskey.

### Example 13. Effect of Liquor Blending Water at pH<6.5 & >8.5

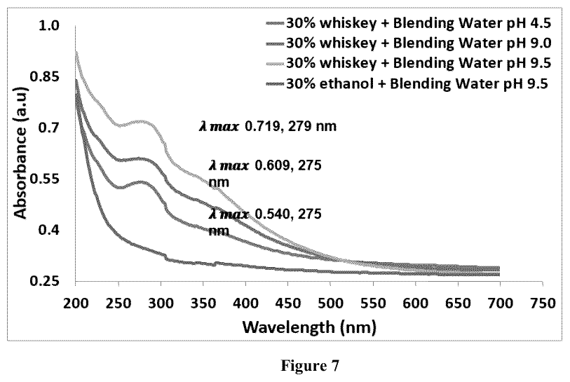

The initial analysis was done at pH ranging from 6.5 to 8.5. It was done because of is range approved for drinking by World Health Organization (WHO). However our Liquor Blending water works completely fine at pH range of <6.5 & >8.5. In order to further prove the concept, we prepared the Liquor blending water at pH 4.5 and 9.5. After that we blended the whisky as mentioned before in our liquor blending water followed by Uv-vis spectral analysis. Indeed, we observed a similar pattern as observed for 6.5-8.5 pH range. The λ max was lower for liquor blending water at pH 4.5 and higher for pH 9.5. This observation again proves the working of liquor blending water by increasing or decreasing the solvation the liquor molecule based upon the formulation, concentration and pH status. In addition to that. Liquor blending water works in the range of pH 4.5 to 9.5. FIG. 7 depicts UV-Vis Spectra of Whiskey in Blending Water at basic pH range of 9.0 and 9.5. Peak opening is clearly visible as well as a hyper chromic shift is visible with increase in pH of the innovative blending water.

### Example 14: Effect of Liquor Blending Water on Higher Concentration

Till present study applicant have seen the effect of liquor blending water on standard peg concentrations. However, in real life conditions, the quantity of liquor might vary depending upon the consumer's consumption preferences. So next we did the analysis of the effect of Liquor blending water at higher concentrations of liquor. For that, we took 50% and 80% whiskey blending with liquor blending water and analyzed the peak opening with Uv-Vis spectrometry. We observe a similar pattern at the standard range of pH 6.5, 7.0, & 8.5. For 50% dilution, peak opening was more for pH 8.5, lower for pH 6.5 and pH 7.5 was in middle. However, there was marginal peak enhancement from pH 6.5 to pH 7.0. The reason for that, is lesser solvation at 50% as compared to 30% as observed in FIG. 2.3.4. However at pH 8.5 the peak increment is similar to that of 30% because of enhanced effect Liquor blending water. Whereas at 80% the peak opening pattern and taste enhancement is similar to 30%. Because 80% have similar solvation effect to 30%.

### Example 15: Effect of Liquor Bending Water on Vodka

On a similar pattern, applicant further analysed the effect of blending water on vodka. As described above vodkas are mostly flavored one and are consumed mostly for their flavour not for their alcohol's taste. So we used similar concentration amount of vodka and blended it with our proprietary liquor blending water. After that we did Uv-vis spectral analysis. As described above, we observed an increase in the absorbance value with an increase in the pH of our liquor blending water and vice versa. So for decreasing the alcoholic taste of vodka, it can be mixed within the range of 6.5 or 7.5 pH depending upon the requirement. But based on our market analysis, we have created one formula having a pH range between 6.5 to 7.5, to be used directly for blending the vodka.

### Example 16: Entropy Studies: Effect of Liquor Blending Water on Blending with Liquor

Entropy is well known concept in thermodynamics, is the concept of entropy. Liquid and gas molecules are particularly in dynamic movement known as brownian motion (except solids where motion is highly restricted in the mode of vibrations). So when two liquids are mix together, the same space is occupied by two liquid molecules. Due to space restrictions, the movement of the both the liquid molecules gets restricted. This restriction is also referred to as entropy reduction. This decrease gets more enhanced, when whiskey is blended with water due to formation of cage like structure as explained before. So, if liquor blending water is enhancing the flavour, then in that case, it will result in the increase in entropy. So to prove that, we did entropy analytical studies.

### Experimental Design:

We took blending water and heated it to 50° C. (approximate) and then blended it with whiskey at the same ratio of 30%. The blending water formulation was taken at standard pH range of 6.5 to 8.5 (just to prove technology working). After blending the final temperature was recorded of the final mixture. It was observed that the final temperature after mixing increased with the pH of the liquor blending water as depicted in following table.

TABLE 8
Effect on temperature on addition of “blending water”.

| Liquor | | | | |
|---|---|---|---|---|
| Blending | Heated | | Whisky | Temperature |
| water | Temperature | | Temperature | after mixing |
| (pH) | (° C.) | Liquor | (° C.) | (° C.) |
| 6.5 | 50.4 | Whisky | 33.2 | 46.5 |
| 7.0 | 51.0 | Whisky | 31.7 | 48 |
| 8.5 | 50.8 | Whisky | 33.2 | 49.6 |

Increase in the temperature is directly proportional to increase in entropy.

$$Δ S = Q / {T}_{avg} = mc Δ T / {T}_{avg}$$

$$Δ S = Δ T$$

Thus, Change in the entropy is directly proportional to change in temperature.

This data directly confers more opening of whiskey/guaicol molecule. This has resulted in more taste opening and flavour enhancement, when we go higher in pH range and vice versa happens towards the lower range.

The above observation of temperature range was further confirmed by entropy value calculation.

That showed the increase in entropy values upon increasing the pH of the formulation. The values have been calculated by the following standard procedure:

$$ΔS = Q / {T}_{avg} = m c Δ T / {T}_{avg}$$

Two different entrap change were calculated viz

$$Δ {S}_{, water} = m c Δ {T}_{water} / {T}_{avg}$$

$$Δ {S}_{whiskey} = m c Δ {T}_{whiskey} / {T}_{avg}$$

### Final Entropy Change:

$$Δ S = Δ {S}_{water} + Δ {S}_{whiskey}$$

### Abbreviations:

$$Δ T = {T}_{final} - {T}_{initial}$$

ΔS: Change in entropy in Joules/gm
Q: heat change in Joules
c: specific heat
m: mass
Tavg: Average temperature of the mixture in Kelvin
ΔT: Change in the temperature

As can be seen in the table there has been a gradual increase in the entropy from pH 6.5 to pH 8.5. This again proves that whiskey/guaiacol molecules are getting opened, which in turn are giving us the enhanced flavour. The following table depicts the effect of pH change of liquor blending water of present invention over the entropy.

TABLE 9
Effect of pH change of “blending water” over entropy.

| | | Actual |
|---|---|---|
| Liquor Blending | To be entropy | Entropy |
| water (pH) | J K⁻¹ M⁻¹ | J K⁻¹ M⁻¹ |
| 6.5 | −5.33 | −0.907 |
| 7.0 | −5.55 | 0.626 |
| 8.5 | −51379 | 1.9388 |

### Example 17: pH Balancing Effect

Present liquor blending water also has shown a pH balancing effect. After blending whiskey with liquor blending water, the pH of the solution always tended towards basic aspect. So, after using our blending water, the body will feel less acidity, that sometimes happens after drinking. The following table depicts the effect of pH of liquor blending water over final blended solution.

TABLE 10
Effect of pH change of “blending water” on pH of final solution.

| Liquor Blending water | |
|---|---|
| (pH) | pH Change |
| 6.5 | 0.82 |
| 7.0 | 0.7 |
| 8.5 | 0.79 |

### CONCLUSION

Thus, based on the above experiments, it can be concluded that present liquor blending is breaking the clathrin cage like structure. This structural opening enhances with concentration as well as the pH of present formulation. This formulation has been specifically designed in a fashion to break the hydrogen bonding and thus disrupting the hydrophobic structure leading to better solvation. By better solvation, it means that whiskey molecule will be less surrounded by water molecules via reduction in hydrogen bonding. Further there is gradient increment in flavour and taste enhancement from 4.5 (acidic) to 9.5 (basic) pH levels

1. A composition of concentrate blending water for liquor comprises
a. concentrate A to moderated pH and TDS is a mixture of sodium carbonate in an amount of 48-50 ppm, sodium Hydroxide in an amount of 28-30 ppm, potassium bicarbonate in an amount of 34-36 ppm;
b. concentrate B to moderated pH and TDS is a mixture of calcium carbonate in an amount of 20-22 ppm, potassium carbonate in an amount of 34-36 ppm, sodium bicarbonate in an amount of 30-32 ppm, calcium Chloride in an amount of 20-22 ppm;
C. composition of concentrate C for test and aroma is a mixture of flavor enhancing agent guaicol in an amount of 20-22 ppm, base selected from sorbitol, glycerin present in an amount of 10-20 ppm;
wherein Concentrate A and Concentrate B mixed with stirring for 1-4 hours followed by dropwise addition of Concentrate C with continuous stirring for 10-36 hours.

2. The composition of concentrate blending water for liquor as claimed in claim 1, wherein composition for said blending water comprise
a. sodium carbonate present in amount of 1-50 ppm;
b. sodium hydroxide present in amount of 1-50 ppm;
c. potassium bi carbonate present in amount of 1-50 ppm;
d. calcium carbonate present in amount of 1-50 ppm;
e. potassium carbonate present in amount of 1-50 ppm;
f. sodium bicarbonate present in amount of 1-50 ppm;
g. calcium chloride present in amount of 1-50 ppm;
h. flavor enhancing agent present in amount of 2-5 ppm;
i. base present in amount of 5-6 ppm;
wherein, water having pH in range of 6.5-9.0 and TDS in range of 5-10 present in amount with quantity sufficient up to 1000 ml.

3. The composition of concentrate blending water for liquor as claimed in claim 1, wherein liquor is selected from whiskey, vodka, single malt, gin.

4. The composition of concentrate blending water for liquor as claimed in claim 1, wherein process of preparation of said blending water comprises:
process of preparation of concentrate A to moderated pH and TDS comprises steps of:
g. dissolving sodium carbonate concentration of 48-50 ppm in 1000 ml of demineralized autoclaved water with TDS in range of 5-10 followed by addition of sodium Hydroxide in an amount of 28-30 ppm.
h. stirring solution formed in step (a) for 30-45 min at 30° C.;
i. addition of potassium bicarbonate in solution formed in step (b) in an amount of 34-36 ppm and followed by stirring for 35-45 minutes to form Concentrate A;
process of preparation of concentrate B to moderated pH and TDS comprises steps of:
g. addition of 20-22 ppm of calcium carbonate, 16-18 ppm of potassium carbonate & 30-32 ppm of sodium bicarbonate in 1000 ml of water;
h. stirring solution formed in step (d) for 20-40 min at 70° C.;
i. addition of calcium Chloride in solution formed in step (e) in an amount of 20-22 ppm and followed by stirring for 5-15 minutes to form Concentrate B;
process of preparation of concentrate C for test and aroma comprises steps of:
g. addition 5-10 ppm of guaicol in 1000 ml of water followed by addition 10-20 ppm of sorbitol;
h. stirring solution formed in step (g) for 3 hours at 5° C.;
i. cooling the solution at room temperature to form Concentrate C;
process of preparation of Concentrate blending water for liquor comprises steps of:
g. mixing Concentrate A and Concentrate B with stirring for 2 hours followed by dropwise addition of Concentrate C with continuous stirring for 24 hour.
h. filtration of the solution formed is step (j) to recover final concentrate for preparation of blending water.
i. addition of 60-150 ml of final concentrate in 1000 ml of demineralized water with TDS in the range of 5-10 followed by stirring for one hour to form final blending water for liquor with pH in the range of 6.5-9.0 and TDS in the range of 15-50 ppm,

5. The composition of concentrate blending water for liquor as claimed in claim 4, wherein liquor is selected from whiskey, vodka, single malt, gin.

6. The composition of concentrate blending water for liquor as claimed in claim 1, wherein preparation of blending water for liquor comprises addition of 60-125 ml of Concentrate blending water for liquor in 1000 ml of demineralized water having TDS in the range of 5-10 ppm and pH in the range of 6.5-6.8 followed by stirring for one hour to form final blending water for liquor having pH in the range of 6.5-9.0 and TDS in the range of 15-50 ppm.

7. The composition of concentrate blending water for liquor as claimed in claim 1, wherein blending water for vodka prepared by adding 75-80 ml of concentrate blending water for liquor in 1000 ml of demineralized water having TDS in the range of 5-10 ppm and pH in the range of 6.5-6.8 and was mixed for 1 hour.

8. The composition of concentrate blending water for liquor as claimed in claim 6, wherein the blending water for vodka the pH is in range of 6.5-7.0 pH and TDS is range of 18-25 ppm.

9. The composition of concentrate blending water for liquor as claimed in claim 1, wherein blending water for single malt prepared by adding 90-120 ml of concentrate blending water for liquor in 1000 ml of demineralized water having TDS in the range of 5-10 ppm and pH in the range of 6.5-6.8 and was mixed for 1 hour.

10. The composition of concentrate blending water for liquor as claimed in claim 9, wherein the blending water for vodka the pH is in range of 7.3-7.8 pH and TDS is range of 20-35 ppm.

11. The composition of concentrate blending water for liquor as claimed in claim 1, wherein blending water for whiskey prepared by adding 118-135 ml of concentrate blending water for liquor in 1000 ml of demineralized water having TDS in the range of 5-10 ppm and pH in the range of 6.5-6.8 and was mixed for 1 hour.

12. The composition of concentrate blending water for liquor as claimed in claim 11, wherein the blending water for vodka the pH is in range of 7.9-8.3 pH and TDS is range of 25-36 ppm.

13. The composition of concentrate blending water for liquor as claimed in claim 1, wherein blending water for Gin prepared by adding 120-150 ml of concentrate blending water for liquor in 1000 ml of demineralized water having TDS in the range of 5-10 ppm and pH in the range of 6.5-6.8 and was mixed for 1 hour.

14. The composition of concentrate blending water for liquor as claimed in claim 13, wherein the blending water for vodka the pH is in range of 8.0-8.7 pH and TDS is range of 25-45 ppm.

15. The composition of concentrate blending water for liquor as claimed in claim 1, wherein flavor enhancing agent is guaicol.

16. The composition of concentrate blending water for liquor as claimed in claim 1, wherein base is selected from glycerin and sorbitol.
